(19) United States
(12) Patent Application Publication
(10) Pub. No.: US 2024/0214094 A1
(43) Pub. Date: Jun. 27, 2024

(54) METHOD OPERABLE IN A VEHICLE RADIO SYSTEM

(71) Applicant: iBiquity Digital Corporation, Columbia, MD (US)

(72) Inventor: Ashwini PAHUJA, Roslyn Heights, NY (US)

(21) Appl. No.: 18/536,750

(22) Filed: Dec. 12, 2023

Related U.S. Application Data
(60) Provisional application No. 63/476,637, filed on Dec. 21, 2022.

(51) Int. Cl. H04H 60/41; H04H 20/62; H04H 60/52

(52) U.S. Cl. CPC H04H 60/41; H04H 20/62; H04H 60/52; H04H 2201/13

(57) ABSTRACT

A method operable by a vehicle processor comprises: causing a vehicle receiver to receive a radio broadcast channel; obtaining from the received radio broadcast channel, digital data comprising a respective identifier, transmitting location and broadcasting range for one or more other radio broadcast channels whose broadcasting range overlaps with a broadcasting range of the received radio broadcast channel; determining a location of the vehicle; determining if a broadcasting range of any of the or each other radio broadcast channels overlaps with a location of the vehicle; and outputting for display through a user interface, an indication of available radio broadcast channels including the or each of the other radio broadcast channels determined to have a broadcasting range overlapping with the location of the vehicle.

### FIELD

The present invention relates to a method operable in a vehicle radio system.

### BACKGROUND

It is known to transmit a limited amount of digital information with a radio broadcast, for example, as disclosed in: “DAB—From Digital Radio towards Mobile Multimedia”, Franc Kozamernik, EBU Tech Review 297, 30 Jan. 2004; and “Data over DAB”, Felix Morgner & Tobias Stauber, University of Applied Sciences Rapperswil, 24 Feb. 2016.

U.S. Pat. Nos. 9,872,066 and 9,350,471 disclose transmitting data through HD Radio channels.

It is an object of the present invention to more effectively employ such information.

### SUMMARY

According to the present invention, there is provided a method operable in a vehicle radio system according to claim 1.

According to a second aspect of the present invention, there is provided a vehicle radio system configured to perform the method of the present invention according to claim 10.

According to a third aspect of the present invention, there is provided a vehicle according to claim 11 comprising the vehicle radio system of claim 10.

Described herein are various embodiments of a system and method for building and presenting a station list to a listener. Embodiments of the system and method work with existing receivers. Moreover, there is no need for another tuner performing a background scan to determine other available stations than the one a foreground tuner is tuned to, so saving hardware costs.

Obtaining digital information through a radio broadcast, rather than for example, through a network connection to a server saves valuable network resources.

### BRIEF DESCRIPTION OF THE DRAWINGS

Embodiments of the invention will now be described, by way of example, with reference to the accompanying drawings, in which:

FIG. 1 illustrates a vehicle radio system according to an embodiment of the present invention.

FIG. 2 illustrates a location of a vehicle including a vehicle radio system according to an embodiment vis-à-vis the broadcasting range of a plurality of radio broadcasts.

FIG. 3 illustrates a method operable in a vehicle radio system according to an embodiment of the present invention.

### DESCRIPTION OF THE EMBODIMENTS

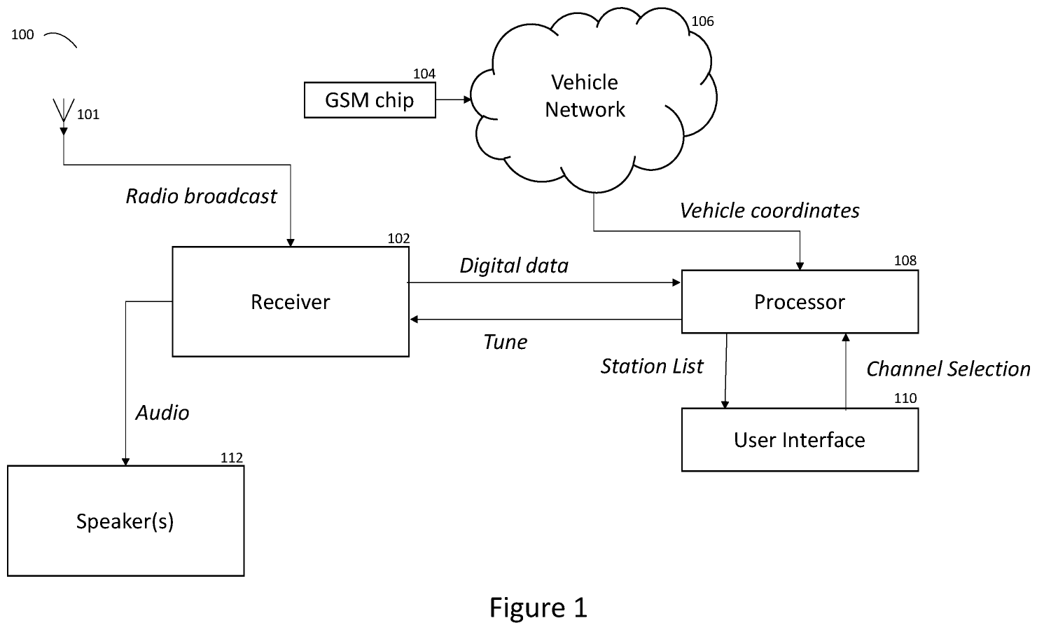

Referring now to FIG. 1, there is illustrated a vehicle radio system 100 according to an embodiment of the present invention. The system 100 comprises an antenna 101 connected to a radio receiver 102 and at any given time, the radio receiver 102 may be tuned to a given frequency in order to receive a broadcast radio channel.

In the described embodiment, the radio receiver 102 is configured to receive a frequency modulated, FM, radio signal carrying an analog audio signal as well as a limited amount of digital data, for example in compliance with the RDS standard.

It will be appreciated that in variants of the embodiment, the radio receiver 102 could be configured to receive an amplitude modulated, AM, radio signal. Where the AM radio signal is transmitted as an analog signal, it may carry a limited amount of digital data such as in the case of the low-rate data service (LRDS) proposed by the US National Association of Broadcasters.

Alternatively, the radio receiver 102 could be configured to receive a digital broadcast signal, such as a HD Radio broadcast in the United States, ISDB-T in Japan, CDR in China or Digital Audio Broadcasting (DAB) broadcast in Europe, which is decoded in order to provide an analog audio signal. In any case, for analog FM or digital broadcast, the audio signal typically comprises stereo components.

In an embodiment, when a user turns on the radio, they select a broadcast radio channel through a user interface 110. A processor 108 retrieves this selection and causes the receiver 102 to adjust its tuner (not shown), if necessary, to detect the desired radio signal carrier frequency for the selected radio broadcast. Alternatively, the radio receiver 102 may already be tuned into a given radio broadcast when the radio is turned on, for example, by keeping in memory the frequency from a previous use of the radio. The received signal is provided to a demodulator (not shown) which outputs a time varying analog audio signal.

Alternatively, where the radio signal is received by AM broadcast, the time-varying audio signal may be extracted using an envelope detector, and if the audio signal is received by digital broadcast, a digital decoder can extract the audio signal.

In any case, the time varying analog audio signal is available within the radio receiver 102 and this would normally be provided to an amplifier (not shown) before being fed through one or more speakers 112 which emit an acoustic audio signal that the user can hear. The connection between the receiver 102 and the speaker(s) 112 can either be wired or wireless, for example, using a Bluetooth connection.

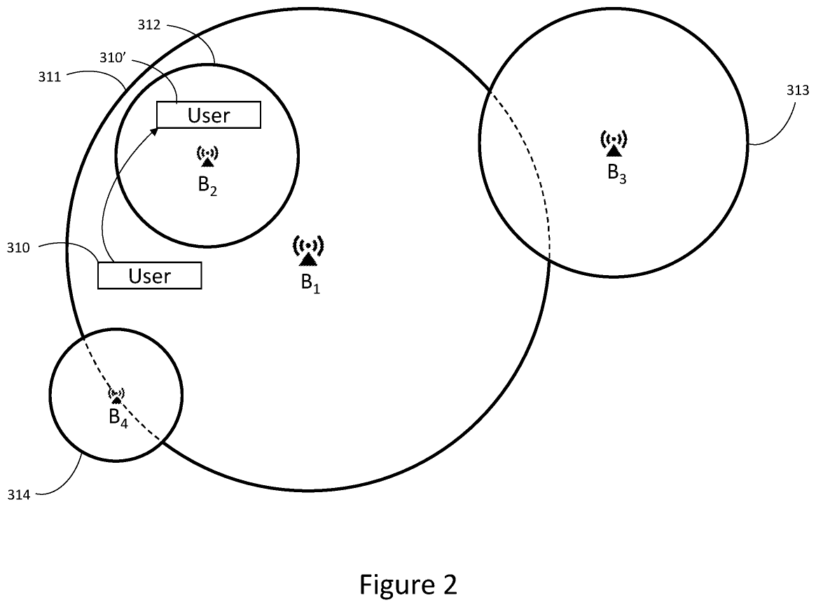

Referring now to FIG. 2, the vehicle radio system 100 is part of a vehicle 310, typically a component of an in-vehicle information system (IVIS). In this case, the radio in the vehicle is tuned into station B₁. B₁ broadcasts its radio signal across a broadcasting range 311 and the vehicle 310 is located within that broadcasting range 311.

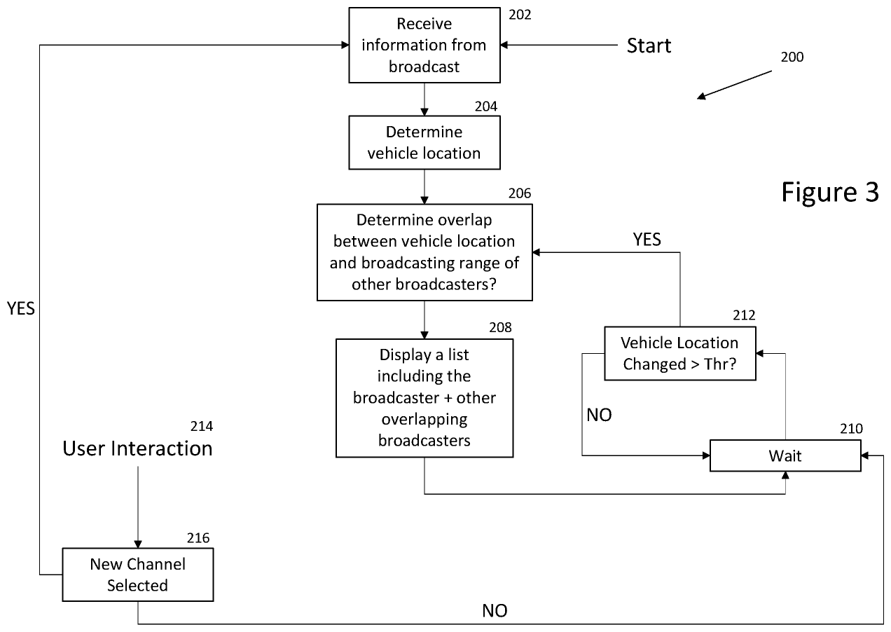

Referring to FIG. 3, there is shown a method 200 performed by the processor 108 according to an embodiment of the invention. At step 202, the processor 108 receives digital data associated with the radio signal from the radio receiver 102. Such digital data can be retrieved from the broadcast signal by the radio receiver 102, where this is provided in digital sideband information, for example using the DAB Transparent Data Channel (TDC). As mentioned above, digital data may be encoded in AM or FM signal, and the radio receiver may be similarly configured to retrieve the digital data from an AM or FM radio broadcast, or indeed any suitable type of broadcast.

Note that in the case of HD Radio in the United States, a digital channel is broadcast adjacent the analog FM or AM signal. The digital audio can be the same as the analog audio, while the supplemental program service(s) (SPS) for the digital channel will typically have different and unique content (example jazz, rock etc.) than associated with the analog signal.

In any case, for HD Radio, any required digital data for the analog station can be obtained from the adjacent digital broadcast.

Typically, the digital data comprises a digital broadcast identifier for the radio broadcast B₁. It will be appreciated that the digital data may comprise additional data such as title of a song being played, or other digital data about the broadcast. It will be appreciated that the digital data service may comprise, for example, a list of frequencies with similar content, for example, if the user is listening to soft rock, a list of soft rock station which may be in the user's vicinity, alternative frequencies for the same broadcasting station, radio text, traffic announcements. Any such digital data can be displayed on the user interface 110 of the vehicle radio system 100.

It will be appreciated that other radio stations may broadcast in the vicinity of station B₁. For example, station B₂ broadcasts its radio signal with a broadcasting range 312, and both the station B₂ and its broadcasting range 312 overlap the broadcasting range 311. Furthermore, while stations B₃ and B₄ may not be located within the broadcasting range 311, it will be appreciated that their respective broadcasting ranges 313 and 314 overlap with the broadcasting range 311.

In any case, the digital data received at step 202 further comprises a digital broadcast identifier, a position and a broadcasting range for every radio broadcast whose broadcasting range overlaps with the broadcasting range 311 of the radio broadcast the receiver 102 is tuned to. In some embodiments of the present invention, each broadcaster can obtain the details of the identifier, location and broadcasting range of other broadcast channels through a network connection to a service provider (not shown), for example, a cloud service, and so incorporate this information as required with radio broadcasts of theirs transmitted from respective locations.

As such, in the example of FIG. 2, as well as the typical digital information associated with the radio broadcast B₁, the radio receiver 102 of the vehicle 310 receives a digital broadcast identifier, a position and a broadcasting range for each of the radio broadcasts B₂, B₃ and B₄.

In step 204, the processor 108 determines a location of the vehicle 310. For example, the processor 108 can retrieve the location of the vehicle from a GSM chip 104 through a vehicle network 106. Such chips may include a receiver implementing a Global Navigation Satellite System, GNSS, including but not limited to a GPS, GLONASS, BeiDou and/or Galileo other device capable of determining absolute and/or relative position of the vehicle 310 based on wireless signals received from space-born and/or terrestrial sources (e.g., eLoran, and/or other at least partially terrestrial systems), for example, and capable of providing such measurements as sensor signals and/or data (e.g., coordinates) that may be communicated to various devices of vehicle radio system 100. The vehicle network 106 can comprise any conventional network such as a CAN bus from Bosch allowing functional nodes within the vehicle to communicate and exchange information with one another. Alternatively, the processor 108 may determine itself the position of the vehicle 310.

At step 206, the processor 108 determines if there is an overlap between the broadcasting ranges received at step 202 and the position of the vehicle 310 determined at step 204.

In step 208, a station list is output to the user interface 110, giving the user a list of the stations that are available and within range of the location of the vehicle 310. As such, the station list may comprise data corresponding to the radio broadcast being listened to and any additional radio broadcast whose broadcasting range overlaps with the location of the vehicle 310.

As can be seen in the example in FIG. 2, the vehicle 310 is only within the broadcasting range 311 of the radio broadcast B₁. In that case, there is no overlap between the vehicle 310 and the broadcasting ranges 312, 313 and 314 of radio broadcasts B₂, B₃ and B₄ respectively.

In this situation, at step 208, the processor 108 instructs the user interface 110 to output a station list comprising only an indicator for the radio broadcast B₁.

If the vehicle 310 is within a broadcasting range of a plurality of radio broadcasts, then, at step 208, the processor 108 instructs the user interface 110 to output a station list comprising the radio broadcast that the vehicle radio receiver 100 is tuned to and every other radio broadcast determined at step 206 to have a broadcasting range overlapping the position of the vehicle 310.

In further embodiments, the display of the user interface 110 may comprise the radio broadcast being tuned to, the other radio broadcasts being available to the user, as well as any other radio broadcast, including but not limited to, any radio broadcasts having been previously tuned to, any radio broadcast that was previously available to the user, or any radio broadcast that a user may have saved, for example as a favourite radio broadcast. Such list of radio broadcast channels may be displayed with the radio broadcast being tuned to, the available radio broadcasts and the other radio broadcasts being separated from one another, but other displaying alternatives may be envisioned.

In any case, following the display of the station list, the vehicle processor 108 waits, step 210, before potentially repeating steps 206, 208.

Following this waiting period, the vehicle processor 108 determines an updated location of the vehicle 310. The vehicle position is typically determined in a similar way to step 204 described above. If a change between the updated location of the vehicle 310 determined at step 204 and after a waiting period is greater than a threshold, then the vehicle processor 108 determines that the vehicle 310 has moved, and the method returns to step 206.

For example, referring back to FIG. 2, the vehicle 310 may travel to a second position as shown with the vehicle 310′, and the change in position may be greater than the threshold. Vehicle 310′ is then within both the broadcasting range 311 of radio broadcast B₁ and the broadcasting range 312 of radio broadcast B₂.

In this example, the vehicle processor 108 will determine that the position of the vehicle 310′ overlaps with the broadcasting ranges 311 and 312 of radio broadcasts B₁ and B₂ respectively.

At step 210, the list displayed at a previous iteration of the method 200 will be updated to reflect the change of radio broadcasts available to the vehicle 310′. In the example of vehicle 310′, the processor 108 will instruct the user interface 110 to display a list comprising the radio broadcast B₁, as in the previous iteration of the method 200, and B₂ which is now available to the vehicle 310′.

As such, the station list displayed by the user interface 110 is dynamically updated to show the radio broadcasts available to the user. If the vehicle 310 moves to within a broadcasting range of a new radio broadcast, the new radio broadcast will be added to the station list. Similarly, if the vehicle 310 moves outside a broadcasting range of a radio broadcast, the station list will be dynamically updated and the radio broadcast that is no longer available to the user will be removed from the station list.

Referring back to step 212, if the vehicle has not moved, or if the change in position is smaller than the threshold, then it is highly unlikely that the station list needs to be updated, and the processor 108 goes back to waiting. It will be appreciated that the waiting time or the threshold may be preset or configurable, but in alternative examples, the threshold may be dynamically adjusted and changed while the user listens to the radio. Thus, if the vehicle is in a location where station availability changes frequently, then the wait time or location threshold may be reduced and vice versa. For example, where a greater number of stations are available, this may indicate that availability is likely to change rapidly and vice versa.

In any case, the processor 108 is configured to iteratively determine an updated position of the vehicle 310, and to determine an overlap between the updated position of the vehicle 310 and the broadcasting range of potentially available radio broadcasts.

The user interface 110 is used to display the station list to the user, but it is typically also configured to receive user input, step 214.

A frequent user input would be a request to change the radio broadcast that the user is listening to. In response to such a request, the processor 108 instructs the radio receiver 102 to tune into the selected new radio broadcast, according to the user input. When a new radio broadcast is tuned in to, the method 200 returns to step 202.

The user interaction 214 may not be a new channel selection. For example, the user may request to increase the volume of the radio broadcast being outputted by the speaker(s) 112. As such, if the user interaction 214 is not a new channel selection, the vehicle processor 108 goes back to waiting.

Another example of a user interaction 214 would be the user simply turning off the radio in the vehicle 310. In that example, it will be appreciated that the method will stop when the radio is turned off, and that the next time the radio is turned on, the radio receiver 102 may still be tuned into the radio broadcast that the user was listening to prior to turning off the radio. Alternatively, the user may turn on the radio requesting a specific station, and in that case, the radio receiver 102 will tune into the selected radio broadcast.

While the above embodiments have been described in terms of an analog FM, AM or digital radio, it will be appreciated that in other embodiments of the invention, the system 100 could form part of a hybrid radio where the processor 108 is capable of establishing a 1-to-1 IP connection with a server across a digital data network. It will be appreciated however, that obtaining the alternative broadcast channel information as described above through a radio broadcast is a much more efficient method for distributing such information than doing so on a vehicle-by-vehicle basis using dedicated messaging.

Many other variations than those described herein will be apparent from this document. For example, depending on the embodiment, certain acts, events, or functions of any of the methods and algorithms described herein can be performed in a different sequence, can be added, merged, or left out altogether (such that not all described acts or events are necessary for the practice of the methods and algorithms). Moreover, in certain embodiments, acts or events can be performed concurrently, such as through multi-threaded processing, interrupt processing, or multiple processors or processor cores or on other parallel architectures, rather than sequentially. In addition, different tasks or processes can be performed by different machines and computing systems that can function together.

The various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The various illustrative logical blocks and modules described in connection with the embodiments disclosed herein can be implemented or performed by a machine, such as a general purpose processor, a processing device, a computing device having one or more processing devices, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor and processing device can be a microprocessor, but in the alternative, the processor can be a controller, microcontroller, or state machine, combinations of the same, or the like. A processor can also be implemented as a combination of computing devices, such as a combination of a DSP and a microprocessor, a plurality of microprocessors, one or more microprocessors in conjunction with a DSP core, or any other such configuration.

Embodiments of the system and method described herein are operational within numerous types of general purpose or special purpose computing system environments or configurations. In general, a computing environment can include any type of computer system, including, but not limited to, a computer system based on one or more microprocessors, a mainframe computer, a digital signal processor, a portable computing device, a personal organizer, a device controller, a computational engine within an appliance, a mobile phone, a desktop computer, a mobile computer, a tablet computer, a smartphone, and appliances with an embedded computer, to name a few.

Such computing devices can typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, and so forth. In some embodiments the computing devices will include one or more processors. Each processor may be a specialized microprocessor, such as a digital signal processor (DSP), a very long instruction word (VLIW), or other micro-controller, or can be conventional central processing units (CPUs) having one or more processing cores, including specialized graphics processing unit (GPU)-based cores in a multi-core CPU.

The process actions or operations of a method, process, or algorithm described in connection with the embodiments disclosed herein can be embodied directly in hardware, in a software module executed by a processor, or in any combination of the two. The software module can be contained in computer-readable media that can be accessed by a computing device. The computer-readable media includes both volatile and nonvolatile media that is either removable, non-removable, or some combination thereof. The computer-readable media is used to store information such as computer-readable or computer-executable instructions, data structures, program modules, or other data. By way of example, and not limitation, computer readable media may comprise computer storage media and communication media.

Computer storage media includes, but is not limited to, computer or machine readable media or storage devices such as Bluray discs (BD), digital versatile discs (DVDs), compact discs (CDs), floppy disks, tape drives, hard drives, optical drives, solid state memory devices, RAM memory, ROM memory, EPROM memory, EEPROM, memory, flash memory or other memory technology, magnetic cassettes, magnetic tapes, magnetic disk storage, or other magnetic storage devices, or any other device which can be used to store the desired information and which can be accessed by one or more computing devices.

A software module can reside in the RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an application specific integrated circuit (ASIC). The ASIC can reside in a user terminal.

Alternatively, the processor and the storage medium can reside as discrete components in a user terminal.

The phrase “non-transitory” as used in this document means “enduring or long-lived”. The phrase “non-transitory computer-readable media” includes any and all computer-readable media, with the sole exception of a transitory, propagating signal. This includes, by way of example and not limitation, non-transitory computer-readable media such as register memory, processor cache and random-access memory (RAM).

The phrase “audio signal” is a signal that is representative of a physical sound.

Retention of information such as computer-readable or computer-executable instructions, data structures, program modules, and so forth, can also be accomplished by using a variety of the communication media to encode one or more modulated data signals, electromagnetic waves (such as carrier waves), or other transport mechanisms or communications protocols, and includes any wired or wireless information delivery mechanism. In general, these communication media refer to a signal that has one or more of its characteristics set or changed in such a manner as to encode information or instructions in the signal. For example, communication media includes wired media such as a wired network or direct-wired connection carrying one or more modulated data signals, and wireless media such as acoustic, radio frequency (RF), infrared, laser, and other wireless media for transmitting, receiving, or both, one or more modulated data signals or electromagnetic waves. Combinations of the any of the above should also be included within the scope of communication media.

Further, one or any combination of software, programs, computer program products that embody some or all of the various embodiments of the system and method described herein, or portions thereof, may be stored, received, transmitted, or read from any desired combination of computer or machine-readable media or storage devices and communication media in the form of computer executable instructions or other data structures.

Embodiments of the system and method described herein may be further described in the general context of computer-executable instructions, such as program modules, being executed by a computing device. Generally, program modules include routines, programs, objects, components, data structures, and so forth, which perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the scope of the disclosure. As will be recognized, certain embodiments of the inventions described herein can be embodied within a form that does not provide all of the features and benefits set forth herein, as some features can be used or practiced separately from others.

1. A method operable by a vehicle processor, the method comprising:
causing a vehicle receiver to receive a radio broadcast channel;
obtaining from the received radio broadcast channel, digital data comprising a respective identifier, transmitting location and broadcasting range for one or more other radio broadcast channels whose broadcasting range overlaps with a broadcasting range of said received radio broadcast channel;
determining a location of the vehicle;
determining if a broadcasting range of any of the or each other radio broadcast channels overlaps with a location of the vehicle; and
outputting for display through a user interface, an indication of available radio broadcast channels including the or each of the other radio broadcast channels determined to have a broadcasting range overlapping with the location of the vehicle.

2. The method of claim 1, further comprising:
receiving a position of the vehicle from a separate processor across a vehicle network.

3. The method of claim 1, wherein said radio broadcast channel comprises one of: a Frequency Modulated, FM; an Amplitude Modulated, AM; or a digitally encoded broadcast.

4. The method of claim 3, comprising obtaining the digital data through the Radio Data System, RDS of an FM broadcast.

5. The method of claim 1, comprising iteratively performing the steps of:
determining a position of the vehicle,
determining for each iteratively determined position of the vehicle, if a broadcasting range of any of the or each other radio broadcast channels overlaps with said iteratively determined position of the vehicle; and
outputting for display through the user interface, an indication of available radio broadcast channels including the or each of the other radio broadcasts determined to have a broadcasting range overlapping with the location of the vehicle.

6. The method of claim 5, further comprising performing said steps in response to determining that the position of the vehicle has changed by more than a threshold amount.

7. The method of claim 1, further comprising:
further outputting for display through the user interface, an indication of radio broadcast channels previously available at said vehicle receiver.

8. The method of claim 7, wherein said broadcast channels previously available comprise radio broadcast channels saved by a user of said vehicle.

9. The method of claim 1, wherein said processor is responsive to user interaction with said user interface to cause said vehicle receiver to tune to a radio broadcast channel selected by a user of said vehicle.

10. A vehicle radio system comprising a receiver capable of receiving a radio broadcast channel, a user interface, and a processor configured to perform the method of claim 1.
